(19) United States
(12) Patent Application Publication
(10) Pub. No.: US 2013/0269549 A1
(43) Pub. Date: Oct. 17, 2013

(54) ELECTRIC EMBOSSER AND EMBOSSING FOLDER FOR USE THEREWITH

(71) Applicant: David Tse, Astoria, NY (US)

(72) Inventor: David Tse, Astoria, NY (US)

(21) Appl. No.: 13/673,553

(22) Filed: Nov. 9, 2012

Related U.S. Application Data
(60) Provisional application No. 61/668,681, filed on Jul. 6, 2012.

(30) Foreign Application Priority Data
Nov. 9, 2011 (CN) 201120442569.5

(51) Int. Cl. B44B 5/00

(52) U.S. Cl. CPC B44B 5/0004
USPC 101/3.1

(57) ABSTRACT

An embossing device includes an electric drive system to provide for high quality embossing. The device may be used with any conventional die. In a preferred embodiment, an embossing folder is provided that allows for embossing and debossing of a material in a single pass through the embossing device.

### CROSS-REFERENCE TO RELATED APPLICATIONS

The present application claims benefit of and priority to Chinese Patent Application No. 201120442569.5 filed Nov. 9, 2011 and U.S. Provisional Patent Application Ser. No. 61/668,681, entitled ELECTRIC EMBOSSER AND EMBOSSING FOLDER FOR USE THEREWITH, filed Jul. 6, 2012, the entire content of each of which is incorporated by reference herein.

### BACKGROUND

1. Field of the Disclosure

The present invention relates to an electric embossing device and an embossing folder for use with the electric embossing device.

2. Related Art

Embossing devices have been used for many years in the stationary and craft industries. Embossing devices typically utilize interchangeable dies, which include desired designs that are embossed onto paper, cardboard, etc. The dies are typically metal or hard plastic and include protrusions on one side with recesses on the other. The paper or other material is placed between the two sides. The die is then provided to an embossing device and pressure is applied to the die by the device to emboss the paper or other item.

Conventional embossing devices typically require manual actuation via a crank or other element to apply the pressure to the die. These devices are typically relatively small and labor intensive.

Accordingly, it would be desirable to provide an embossing device that avoids these and other problems.

### SUMMARY

It is an object of the present invention to provide an electric embossing device and embossing folder for use therewith.

An embossing device in accordance with an embodiment of the present disclosure includes a body, a drive system mounted in the body and configured to advance an element to be embossed through the embossing device and at least one sensor mounted on the body and configured to detect a presence of the element to be embossed, the at least one sensor further configured to activate the drive system to advance the element to be embossed through the embossing device when the presence of the element to be embossed is detected.

An embossing folder in accordance with an embodiment of the present disclosure includes a first panel including at lease one protrusion and at least one recess on an inner surface thereof and a second panel including at least one protrusion and at least one recess formed on an inner surface thereof, the first panel and the second panel connected to each other and movable from a closed position in which the inner surface of the first panel contacts the inner surface of the second panel and an open position in which the inner surface of the first panel is separated from the inner surface of the second panel.

Other features and advantages of the present invention will become apparent from the following description of the invention which refers to the accompanying drawings.

### BRIEF DESCRIPTION OF THE DRAWINGS

FIG. 1 illustrates a front perspective view of an exemplary embodiment of an electric embossing device in accordance with an embodiment of the present disclosure;

FIG. 2 illustrates a rear perspective view of the electric embossing device of FIG. 1;

FIG. 3 illustrates a rear view of the electric embossing device of FIG. 1;

FIG. 3A illustrates the outer surface of a rear portion of the electric embossing device of FIG. 1;

FIG. 3B illustrates an inner surface of the rear portion of the electric embossing device of FIG. 1;

FIG. 3C is a more detailed view of a portion of the inner surface of the rear surface of the electric embossing device of FIG. 3B;

FIG. 4 illustrates a front view of the electric embossing device of FIG. 1;

FIG. 5 illustrates a top view of the electric embossing device of FIG. 1;

FIG. 6 illustrates a bottom view of the electric embossing device of FIG. 1;

FIG. 7 illustrates an exploded view of the electric embossing device of FIG. 1;

FIG. 8 is a more detailed view of the drive system of electric embossing device of FIG. 1;

FIG. 9 is a more detailed view of the motor and transmission of the electric embossing device of FIG. 1;

FIG. 10 is an exploded view of the transmission of the electric embossing device of FIG. 1;

FIG. 11 is a detailed view of an exemplary embodiment of a sensor for use in the electric embossing device of FIG. 1;

FIG. 12 is an exploded view of the sensor of FIG. 11;

FIG. 13 illustrates an exemplary embodiment of an embossing folder suitable for use with the electric embossing device of FIG. 1;

FIG. 14 is a cross-sectional view of the embossing folder of FIG. 13; and

FIG. 15 illustrates an exemplary embodiment of a spacer suitable for use with the embossing folder of FIGS. 13-14 and the embossing device of FIGS. 1-12.

### DETAILED DESCRIPTION OF THE EMBODIMENTS

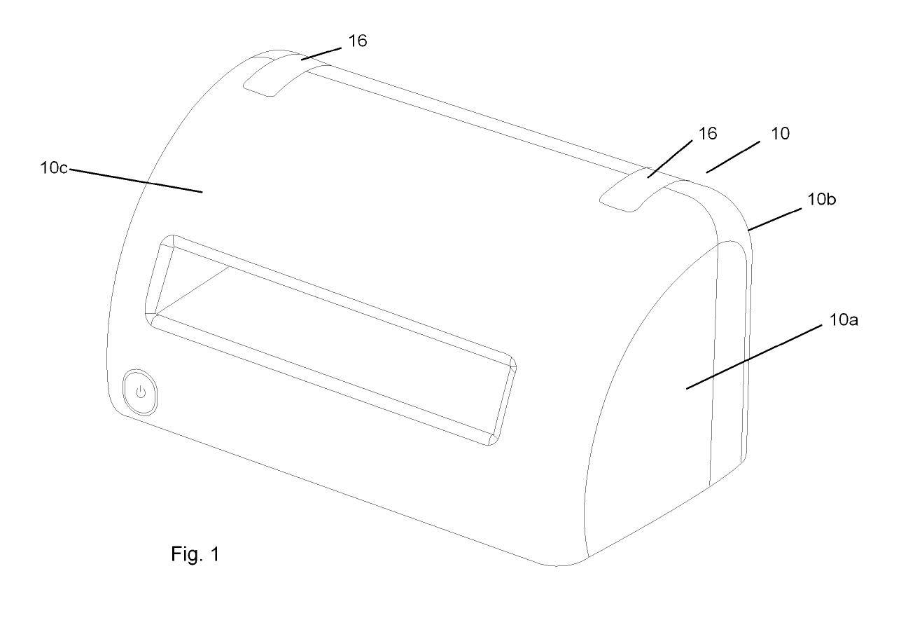

FIG. 1 illustrates an exemplary embodiment of an electric embossing device 10 in accordance with an embodiment of the present disclosure. The device 10 generally includes an outer shell 10a in which a core unit, or drive system and a sensor unit are mounted. The shell 10a may include a rear portion 10b and a front portion 10c. The device 10 includes an input slot 12, configured to receive materials to be embossed. The slot 12 is preferably molded into the front portion 10c of the shell 10a. The materials to be embossed may include, but are not limited to paper, plastic, cardboard, thin sheets of metal or foil etc.

In a preferred embodiment, the slot 12 is sized to accept both the material to be embossed and a die used to set the pattern of embossing. In a preferred embodiment, the size of the slot 12 is selected to accommodate a wide range of dies, and thus, allows for interoperability with dies of other embossing devices. In a preferred embodiment, the slot 12 is sized to accommodate all conventional die assemblies such that the device 10 is suitable for use with any conventional die.

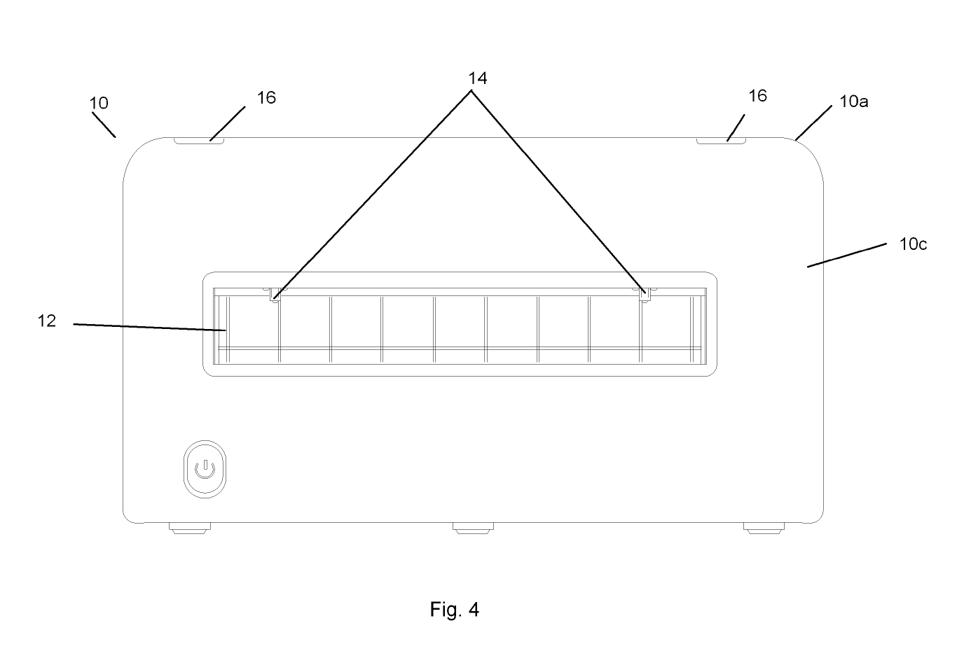

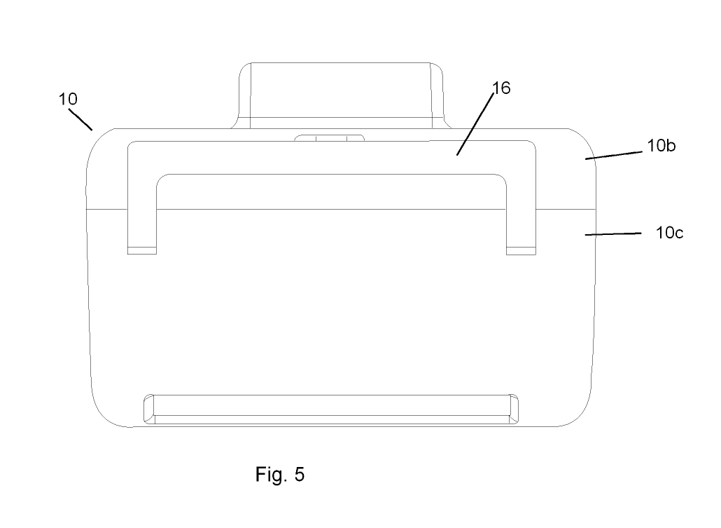

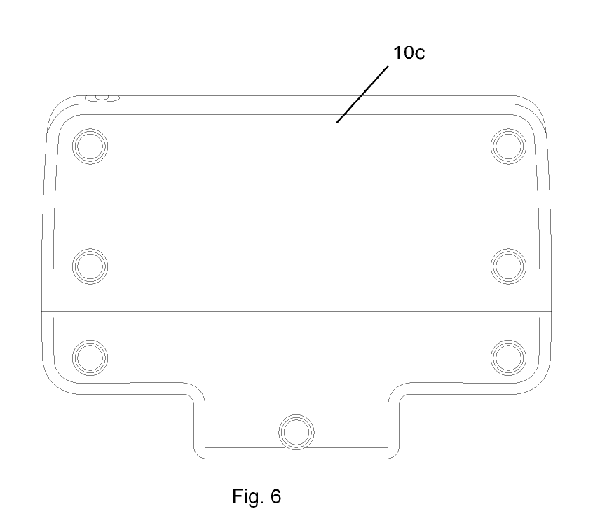

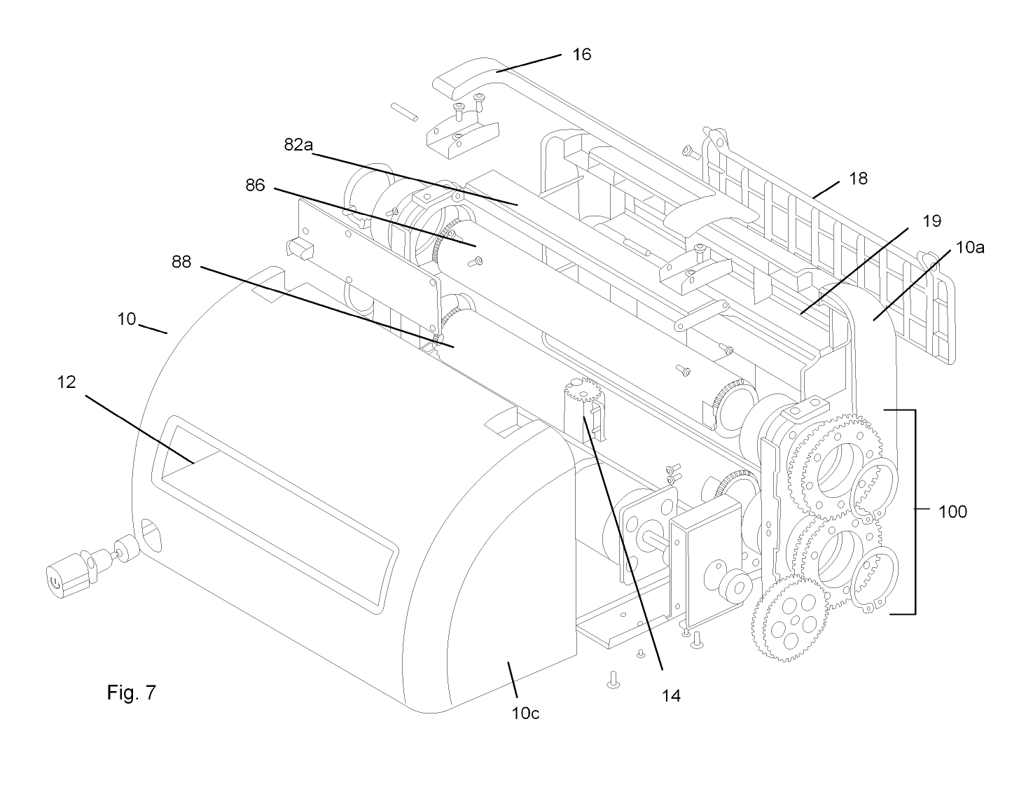

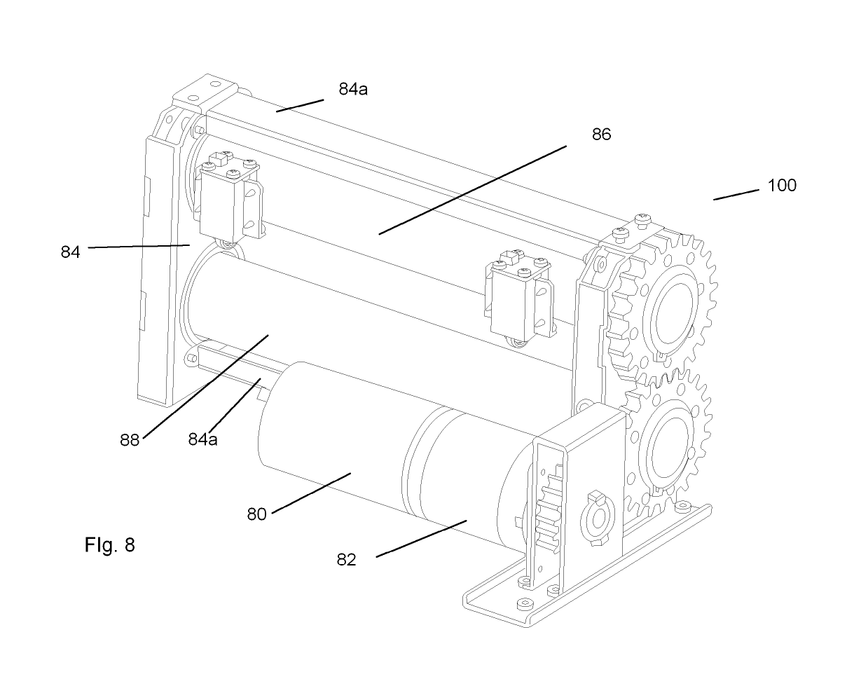

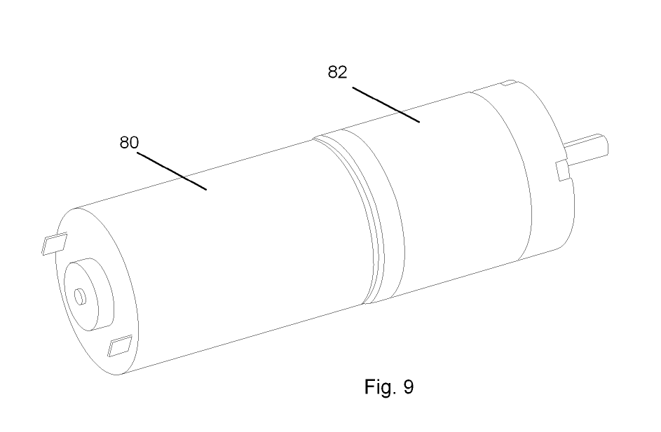

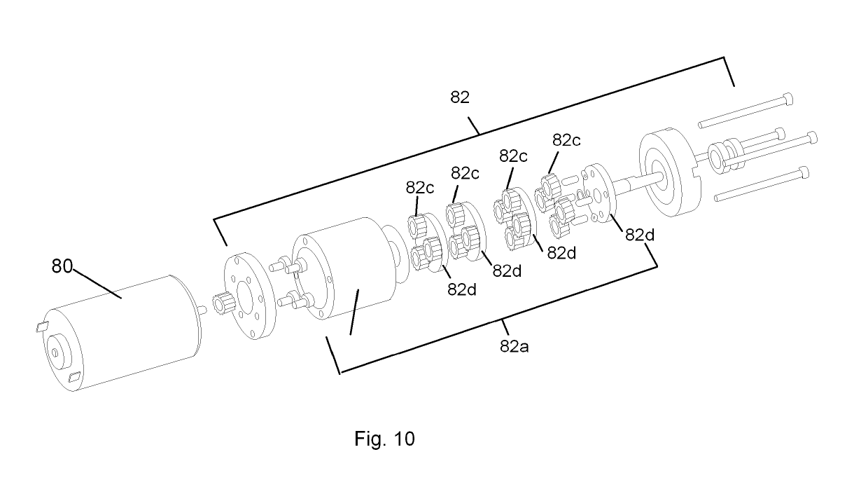

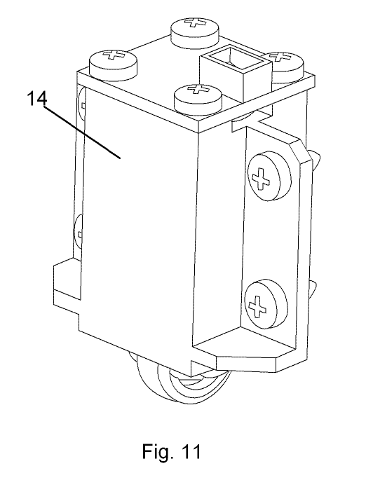

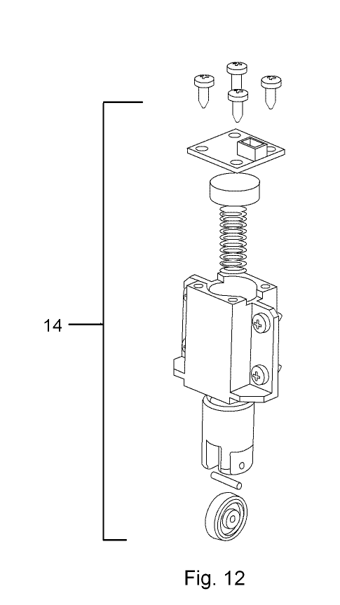

The sensor unit includes a sensor 14, or sensors (See FIG. 4, for example), that are preferably provided inside the slot 12. The sensor 14 prevents operation of the device 10 unless there is a die present in the slot 12. This prevents accidental operation of the embosser 10 that could injure a user's hand or fingers. This further allows for essentially automatic operation of the device 10 whenever a die is present. FIG. 11 illustrates an exemplary embodiment of the sensor 14. FIG. 12 illustrates an exploded view of the sensor 14 in FIG. 11. FIGS. 11-12 illustrate a sensor that uses a roller, or wheel, to contact the die to signify its presence, however, any suitable sensor may be used, including but not limited to an optical sensor. More specifically, when the die is present, the wheel is pushed up against the spring. This upward motion preferably closes a circuit, preferably mounted in a printed circuit board (PCB) that may be a part of the sensor 14 or connected thereto. Closing the circuit preferably results in activation of the device 10, more specifically, activating the motor 80, for example, of FIGS. 9-10. The sensor may also include a current sensing circuit, incorporated into the PCB or elsewhere, which shuts the device 10 down if too much current is drawn by the motor 80. This prevents damage to the motor and helps prevent injury in the event that a user gets a hand or other body part stuck in the device 10.

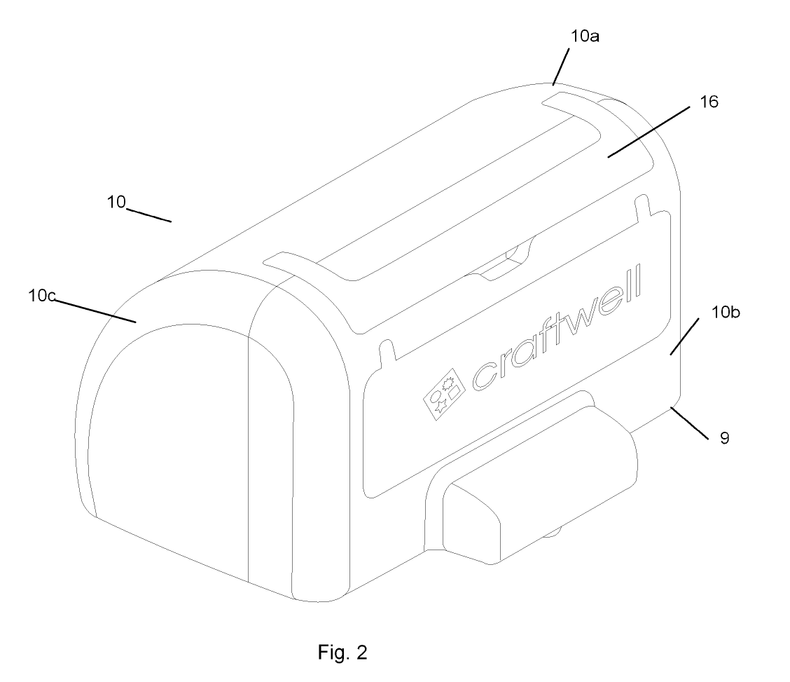

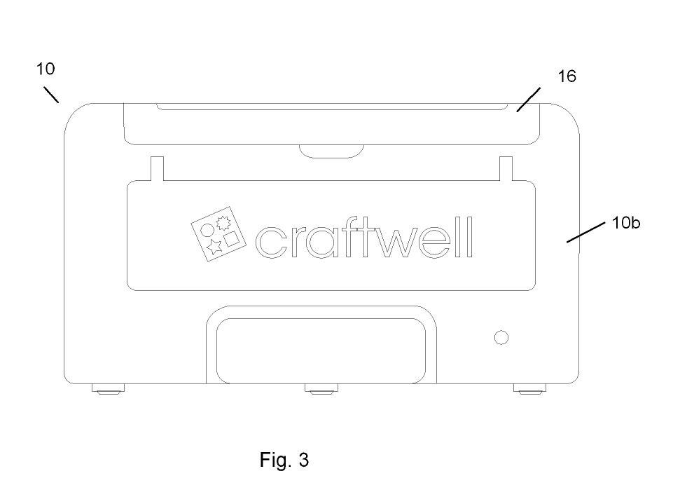

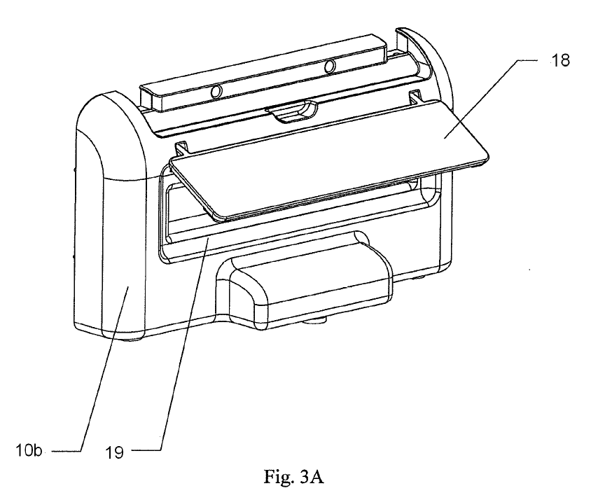

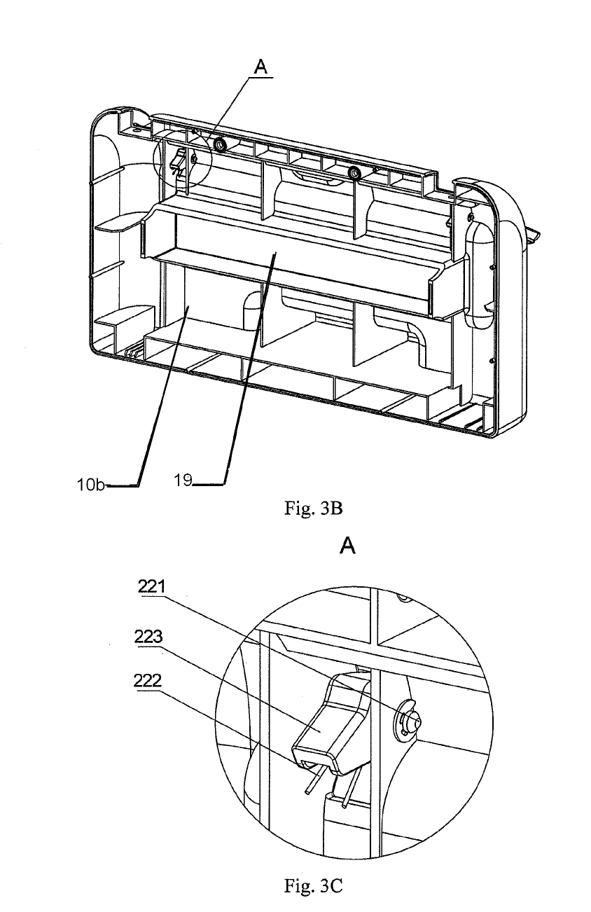

The device 10 is preferably portable and includes a handle 16 (See, FIGS. 1-4, for example) to allow for easy transport of the device 10. The handle 16 is in a closed position in FIGS. 1-4, however, may be raised into an open position to allow a user to easily grasp it. A rear cover 18 (See FIG. 2, for example) may also be provided to selectively cover an output slot 19 of the device 10. In operation, a die, along with the material to be embossed, enters the device 10 via slot 12, passes through the device and out the outlet slot 19. The cover 18 is illustrated in a closed position in FIG. 2, for example, however, opens to allow the die to exit the device when necessary. FIG. 3A illustrates the cover 18 in a partially open position.

In a preferred embodiment, the cover 18 is connected to the rear portion 10b of the shell 10a via a hinge and is configured for automatic closing. That is, the cover 18 is preferably biased into the closed position. In an embodiment, door pins 221 and torsion springs 223 are provided on the inner surface of the back portion 10b of the shell 10a. See FIGS. 3B-3C. When the die exits through the opening 19, the cover 18 is pushed open. After the die exits, the cover 18 will close automatically to cover the outlet slot 19 based on the bias provided by the torsion springs 223.

The die and the material to be embossed are passed through the slot 12 and into the drive system 100 which moves them through the device 10. The drive system 100 is illustrated in detail in FIG. 10 and includes motor 80, gearbox or transmission 82, frame 84 and rollers 86 and 88. The rollers 86, 88 are mounted in the frame 84 which a predetermined gap G between them. The gap G is sized to allow the die and the material to be embossed to pass between the rollers. Specifically, the gap G is sized such that it is large enough to accommodate virtually any existing die.

The rollers 86, 88 provide firm and consistent pressure on the die as it moves through the device 10. This relatively high and constant pressure results in good embossing quality. The rollers 86, 88 may be hollow. Further, the frame 84 includes support structures 84a that prevents the rollers 86, 88 from flexing during operation. This ensures constant application of pressure on the die and the item to be embossed as it passes through the device 10.

In a preferred embodiment, the motor 80 is an electric motor. The motor 80 may be an AC motor or a DC motor, as desired. The motor 80 may be powered by a battery, if desired, or may be connected to line voltage. A suitable voltage transformer may be included in the device 10 if desired.

The gearbox, or transmission, 82 preferably includes a planetary gear arrangement 82a, which can be seen in more detail in FIG. 10, for example. The planetary gear arrangement 82a includes gear ring 82b, planetary gears 82c, a sun wheel or gear and wheels or dials 82d. The planetary gear arrangement 82a provides for efficient operation while minimizing noise from the operation of the device 10. The transmission 82 is preferably linked to the rollers 86, 88 to drive the rollers in opposite directions to drive the item being embossed, and die through the device 10.

In operation, a die, in which a material to be embossed is mounted is fed into the device via the slot 12. The die contacts the sensor(s) 14. When the sensor(s) 14 senses the presence of the die, the motor 80 is activated to begin rotating the rollers 86, 88 via gearbox or transmission 82. That is, the wheel of the sensor 14 is pushed upward against the spring to close the circuit, either on the PCB or elsewhere to provide current to drive the motor 80. The die with the item to be embossed is placed between the rollers 86, 88 in the gap G and pulled through the device 10 by rotation of the rollers. The rollers 86,88 apply pressure to the die to emboss the material therein. The die then passes out the rear slot 19 and can be opened to access the embossed material therein

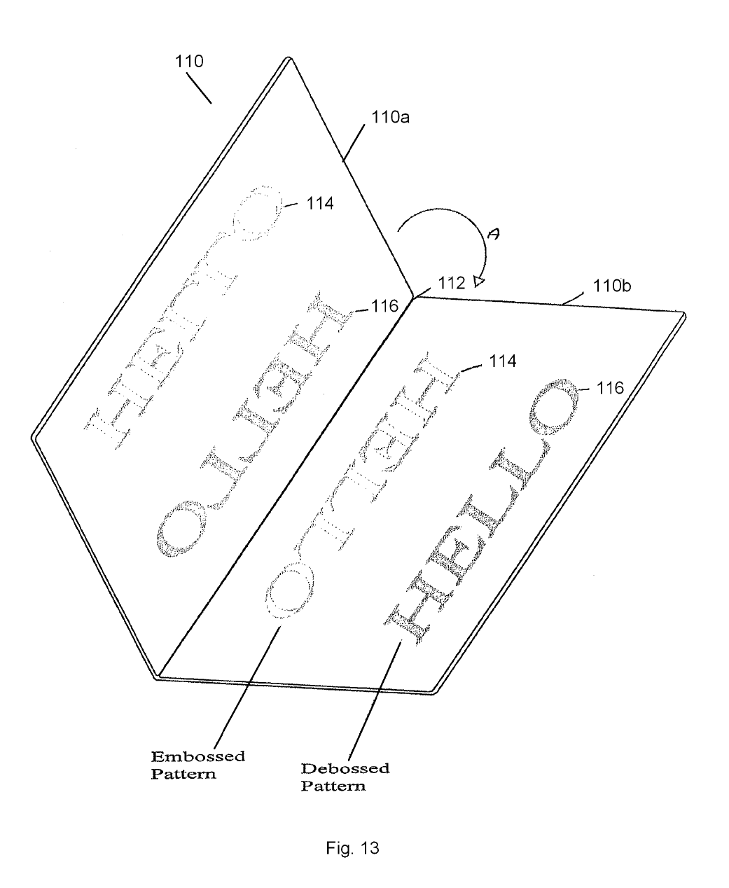

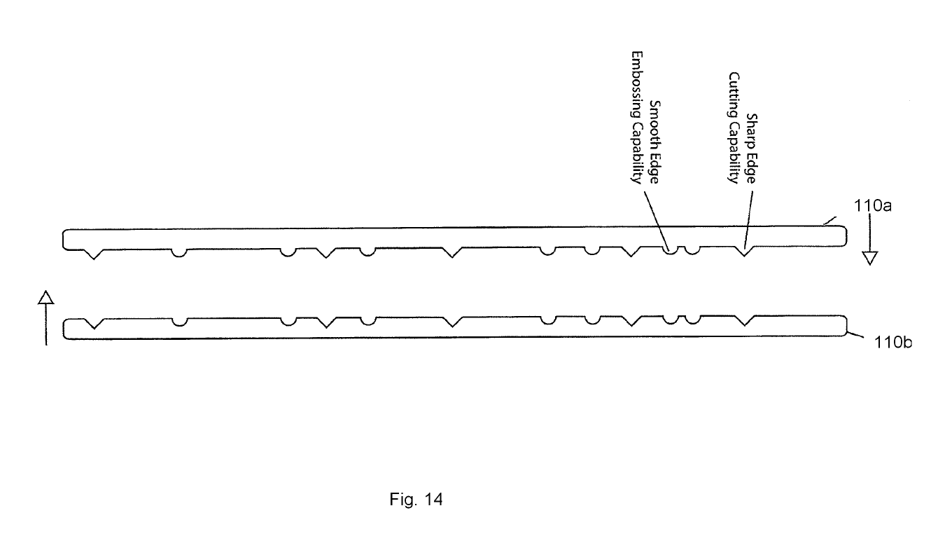

In one embodiment, the die may be a die folder or embossing folder 110, such as that illustrated in FIG. 13. The folder 110 of FIG. 13 includes two opposing panels 110a, 110b that are connected via a spine 112 and are rotatable relative to one another as illustrated by the arrow A. Each panel 110a, 110b includes protrusions 114 extending from an inner surface thereof and recesses 116 formed on the inner surface thereof. Protrusions 114 of one panel are aligned with recesses on the opposing panel such that the material to be embossed is pressed between the protrusions and the recesses to form the desired embossed pattern therein. Specifically, in the folder 110, protrusions and recesses are formed in each of the panels 110a, 110b such that the material in the folder may be embossed and debossed at the same time in a single pass through the device 10. That is, the item to be embossed may be indented in one direction by one of the panels and in the opposite direction by the other panel. FIG. 13 illustrates the folder 110 open such that a material to be embossed may be positioned therein. Thereafter, the folder is closed by rotating the panel 110a over the panel 110b with the material between the panels. The folder 110 is then passed through the device 10 and the rollers 86-88 apply pressure thereto to emboss and deboss the material therein.

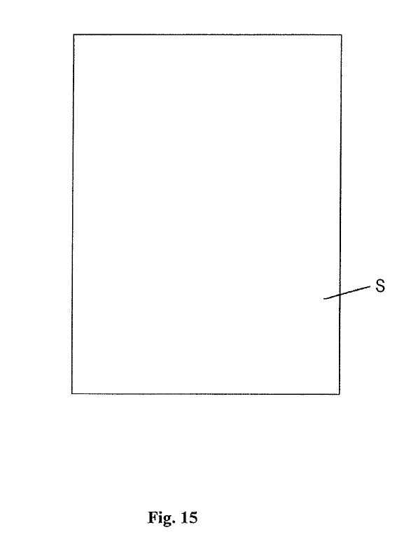

The device 10 is configured to accommodate virtually any die and/or die folder. That is, the slot 12 and the gap G between the rollers 86, 88 is large enough to accept all known dies. A spacer or spacers may be provided, if necessary, and used with the die to ensure that the rollers 86,88 provide sufficient force to the die to provide a high quality embossing pattern. Thus, the device 10 is suitable for use with virtually any existing die. An exemplary embodiment of a spacer S is illustrated in FIG. 15, for example. Additional spacers having different widths may also be provided. The spacers S are preferably rectangular in shape to complement the panels of the folder 110. The spacers S may have different cross-sectional widths, however, such that one or more spacer S can be combined the folder 110, or any other die, to have a total thickness substantially the same as the gap G between the rollers. Thus, pressure is applied to the die and the item to be embossed by the rollers 86, 88 through the spacers S. The spacer S is preferably provided on top or bottom of the die, or die folder, to ensure that the rollers 86, 88 apply pressure thereto. If desired, a spacer S could be provided both on top and on the bottom of the die.

While the device 10 is referred to herein as an embossing device, it is noted that the device 10 may be used to cut paper or other materials as well. In this case, cutting dies are used in place of embossing dies. The device 10 is preferably configured to accommodate both embossing and cutting dies. Cutting dies are typically made of metal and include sharp edges to cut material placed therein.

The embossing folder 110 may also be configured as a cutting die to cut at least certain materials. The folder 110 is preferably made of plastic, and therefore, is suitable for cutting softer materials, such as fondant and sugar sheets, for example.

Although the present invention has been described in relation to particular embodiments thereof, many other variations and modifications and other uses will become apparent to those skilled in the art.

What is claimed is:

1. An embossing device comprising:
a body;
a drive system mounted in the body and configured to advance an element to be embossed through the embossing device; and
at least one sensor mounted on the body and configured to detect a presence of the element to be embossed, the at least one sensor further configured to activate the drive system to advance the element to be embossed through the embossing device when the presence of the element to be embossed is detected.

2. The embossing device of claim 1, wherein the body further comprises:
a bottom panel;
a front panel extending upward from the bottom panel;
a rear panel extending upward from the bottom panel opposite the front panel;
a pair of side panels extending upward from the bottom panel adjacent to the front panel and the rear panel; and
a top panel, positioned opposite the bottom panel connecting the front panel, side panel and pair of side panels.

3. The embossing device of claim 2, wherein the front panel further comprises an input opening formed therein, the input opening sized and configured to receive the element to be embossed.

4. The embossing device of claim 3, wherein the input opening is configured to receive the item to be embossed and a die in which the item to be embossed is positioned.

5. The embossing device of claim 4, wherein the rear panel further comprises an exit opening formed therein, the exit opening sized and configured to pass the element to be embossed out of the embossing device.

6. The embossing device of claim 5, further comprising a cover element configured to move from a closed position in which the cover element covers the exit opening of the rear panel and an open position in which the exit opening is exposed to allow the element to be embossed to exit the embossing device.

7. The embossing device of claim 6, wherein the cover element is biased into the closed position.

8. The embossing device of claim 1, wherein the drive system further comprises:
a motor;
a transmission element connected to and driven by the motor;
a frame connected to the body;
a first roller mounted on the frame;
a second roller mounted on the frame under the first roller such that a predetermined gap is provided between the first roller and the second roller,
the first roller and the second roller connected to the transmission such that the transmission drives the firs roller and second roller to advance the element to be embossed through the device.

9. The embossing device of claim 8, wherein the gap between the first roller and the second roller is sized to ensure that the first roller and second roller provide even pressure to the element to be embossed.

10. The embossing device of claim 8, further comprising at least one support element, attached to the frame and configured to prevent at least one of the first roller and the second roller from flexing.

11. The embossing device of claim 8, wherein the transmission comprises a planetary gear assembly.

12. The embossing device of claim 8, further comprising a current sensing circuit, the current sensing circuit configured to detect current drawn by the motor and to deactivate the motor when the current drawn by the motor exceeds a predetermined threshold.

13. An embossing folder comprising:
a first panel including at least one protrusion and at least one recess on an inner surface thereof; and
a second panel including at least one protrusion and at least one recess formed on an inner surface thereof;
the first panel and the second panel connected to each other and movable from a closed position in which the inner surface of the first panel contacts the inner surface of the second panel and an open position in which the inner surface of the first panel is separated from the inner surface of the second panel.

14. The embossing folder of claim 13, further comprising a hinge configured to connect the first panel to the second panel.

15. The embossing folder of claim 13, wherein the first panel and second panel are configured to hold an element to be embossed between the first panel and the second panel when they are in the closed position.

16. The embossing folder of claim 15, wherein the at least one protrusion of the first panel contacts the element to be embossed to emboss the element to be embossed in a first direction and the at least one protrusion of the second panel contacts the element to be embossed to emboss the element to be embossed in a second direction, opposite the first direction.

17. The embossing folder of claim 15, wherein the at least one protrusion of the first panel and the at least one protrusion of the second panel has a rounded inner end that contacts the element to indent the element to be embossed.

18. The embossing folder of claim 15, wherein the at least one protrusion of the first panel and the at least one protrusion of the second panel has a sharp inner end that cuts the element to be embossed.

19. The embossing device of claim 13, wherein the first panel and the second panel are made of a hard plastic material.

20. The embossing device of claim 13, wherein the first panel and the second panel are made of a metal.
